(19) United States
(12) Patent Application Publication
(10) Pub. No.: US 2023/0044443 A1
(43) Pub. Date: Feb. 9, 2023

(54) WASTE TONER SOLIDIFICATION AND DISCHARGE

(71) Applicant: HEWLETT-PACKARD DEVELOPMENT COMPANY, L.P., Spring, TX (US)

(72) Inventors: Jeong Chul SONG, Seongnam-si, Gyeonggi-do (KR); Sang Uk JEON, Seongnam-si, Gyeonggi-do (KR); Myung Hee JANG, Seongnam-si, Gyeonggi-do (KR)

(21) Appl. No.: 17/790,993

(22) PCT Filed: Dec. 11, 2020
(86) PCT No.: PCT/US2020/064591

§ 371 Date: Jul. 6, 2022

(30) Foreign Application Priority Data
Jan. 14, 2020 (KR) 10-2020-0004921

(51) Int. Cl. G03G 21/10

(52) U.S. Cl. CPC G03G 21/10; G03G 2221/0005

(57) ABSTRACT

An image forming apparatus includes a body a printing engine to perform an image forming operation, a waste toner withdrawal device to obtain waste toners generated during the image forming operation, and a waste toner treatment device to treat the waste toners obtained by the waste toner withdrawal device and introduced to the waste toner treatment device from the waste toner withdrawal device. The waste toner treatment device includes a waste toner discharging member, a heating portion to heat the waste toners within the heating portion, and a driving portion to move the heating portion along a longitudinal direction of the waste toner discharging member so as to form a waste toner solidified within the heating portion from the waste toners heated by the heating portion. The waste toner discharging member discharges the waste toner solidified within the heating portion outside of the heating portion.

### BACKGROUND

An image forming apparatus such as a printer and a copier using an electrophotographic manner includes a photoconductor on which a toner image is formed, a cleaning blade scraping off the remaining waste toners from the photoconductor after transferring the toner image onto a printing medium such as paper or an intermediate transfer body, and a waste toner withdrawal device receiving the waste toners removed by the cleaning blade and sending the waste toners to a waste toner collection container.

### BRIEF DESCRIPTION OF THE DRAWINGS

FIG. 1 is a schematic view illustrating an image forming apparatus having a waste toner treatment device, according to an example;

FIG. 2 is an exploded perspective view illustrating the waste toner treatment device according to an example;

FIG. 3 is a perspective view illustrating an inner side of the waste toner treatment device according to an example;

FIG. 4 is a cross-sectional view of the waste toner treatment device according to an example, illustrating a case where a heating portion is at a first position;

FIG. 5 is a perspective view illustrating a gear connection structure of a driving portion of the waste toner treatment device according to an example;

FIG. 6 is a cross-sectional view of the waste toner treatment device according to an example;

FIGS. 7A to 7H are schematic views sequentially illustrating processes of solidifying and discharging waste toners collected through the waste toner treatment device, according to an example;

FIG. 8 is a perspective view illustrating a waste toner treatment device according to an example;

FIG. 9 is an exploded perspective view illustrating an inner side of the waste toner treatment device according to an example; and

FIGS. 10A to 10H are schematic views sequentially illustrating processes of solidifying and discharging waste toners collected through the waste toner treatment device, according to an example.

### DETAILED DESCRIPTION

Hereinafter, various examples will be described with reference to the drawings. Examples described below may be modified into several different forms. In order to more clearly describe features of examples, a detailed description for contents known to those skilled in the art to which the following examples belong will be omitted.

When any component is referred to as being “connected to” another component in the disclosure, it means that any component and another component are “directly connected to” each other or are “connected to” each other with the other component interposed therebetween. In addition, when any component is referred to as “including” another component, it means the inclusion of other components rather than the exclusion of other components, unless explicitly described to the contrary.

In the disclosure, an “image forming job” may refer to various jobs (for example, printing, scanning, or faxing) related to an image, such as forming of the image, creating/storing/transmitting of an image file, or the like, and a “job” may refer to the image forming job, as well as include a series of processes for performing the image forming job.

In addition, an “image forming apparatus” may refer to an apparatus that prints printing data created in a terminal apparatus such as a computer on a printing medium. An example of such an image forming apparatus may include a copier, a printer, a facsimile, a multi-function printer (MFP) in which functions of the copier, the printer, and the facsimile are complexly implemented through one apparatus, or the like.

The waste toner collection container of an image forming apparatus may have a limit to its capacity to collect waste toners, and thus may need to be regularly replaced. In general, it is difficult to avoid leakage of the waste toners to the outside in a process of replacing the waste toner collection container. The waste toners leaked to the outside may contaminate an interior of the image forming apparatus, as well as contaminate indoor air.

As an example device for replacing the waste toner collection container, a waste toner treatment device capable of increasing eco-friendliness and user convenience has been demanded.

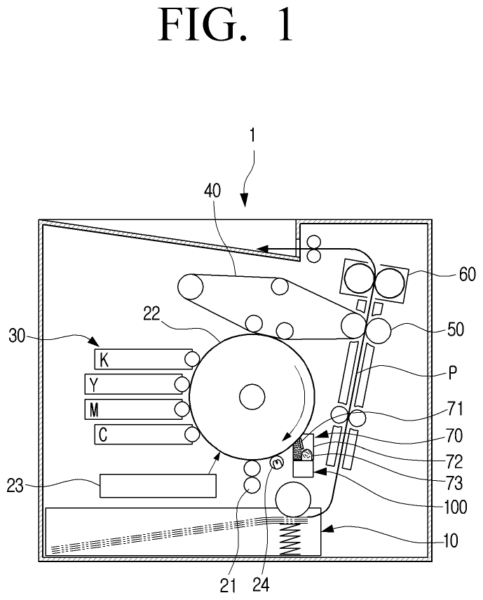

FIG. 1 is a schematic view illustrating an image forming apparatus having a waste toner treatment device, according to an example.

In FIG. 1, a bold solid line indicated by reference sign P denotes a progress path of a printing medium. In FIG. 1, a body of an image forming apparatus 1 is not given a reference numeral, but may be a portion forming an outer shape of the image forming apparatus 1.

A paper feeding device 10 may store a printing medium such as paper. The printing medium may be transported along the progress path P by a plurality of transport rollers (not illustrated).

A charging device 21 may charge the photoconductor 22 with a predetermined potential. The photoconductor 22 may be manufactured by forming a photosensitive material layer on an outer periphery of a metal drum. The photoconductor 22 may be formed in a belt shape instead of a drum shape. A light scanning device 23 may scan the photoconductor 22 with light to form an electrostatic latent image corresponding to printing data on the photoconductor 22. The charging device 21, the photoconductor 22, and the light scanning device 23 may configure a printing engine forming an image on a printing medium.

An electric charge removing device 24 may be disposed adjacent to the photoconductor 22 to remove an electric charge remaining on the photoconductor 22 after toner images are transferred onto a transfer belt 40.

Four developing devices 30 store toners in a solid powder state having four colors, that is, cyan (C), magenta (M), yellow (Y), and black (K), respectively. The four developing devices 30 form the toner images by supplying a toner to the latent electrostatic image formed on the photoconductor 22.

The transfer belt 40 may be an example of an intermediate transfer medium accommodating the toner images from the photoconductor 22 and transferring the toner images to the printing medium. The toner images having four colors, that is, cyan (C), magenta (M), yellow (Y), and black (K), sequentially formed on the photoconductor 22 are sequentially transferred and superposed onto the transfer belt 40.

A transfer roller 50 may be installed on an opposite side of the transfer belt 40, and when the printing medium passes between the transfer belt 40 and the transfer roller 50, a color toner image may be transferred to the printing medium.

A fixing device 60 may fix the toner image transferred to the printing medium through heat and pressure. The printing medium on which the toner image may be fixed is discharged to the outside of the image forming apparatus 1 by a plurality of transport rollers (not illustrated), such that a printing process is completed.

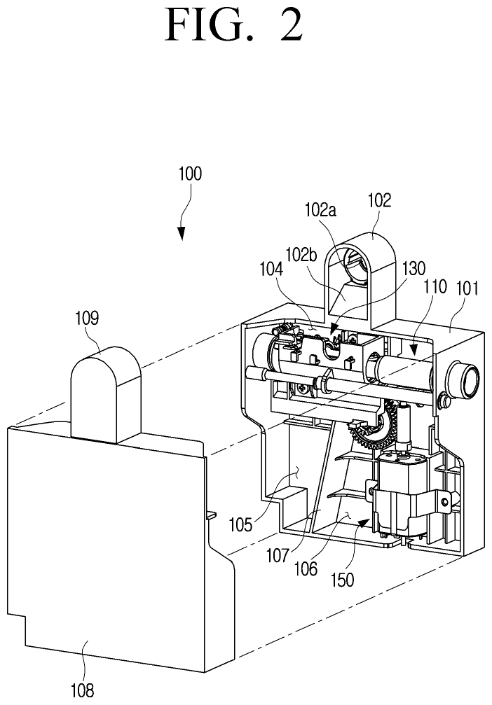

A waste toner withdrawal device 70 includes a blade 71 in contact with the photoconductor 22 in order to scrape off waste toners remaining on a surface of the photoconductor 22. The waste toners removed from the photoconductor 22 using the blade 71 are temporarily maintained in a case 72. The waste toners removed from the photoconductor 22 by the waste toner withdrawal device 70 are transported to a waste toner treatment device 100 by a transport screw 73 disposed in the case 72. In the waste toner treatment device 100, a waste toner inlet 102a (see FIG. 2) provided in a housing 101 (see FIG. 2) to be described later may be connected directly to a waste toner outlet (not illustrated) of the waste toner withdrawal device 70 or be connected indirectly to the waste toner outlet (not illustrated) of the waste toner withdrawal device through a separate passage (not illustrated).

The waste toner treatment device 100 collects the waste toners in a particle form, solidifies the waste toners in a pellet form through heating, pressing, and cooling operations, and then discharges the solidified waste toner. An example reason for solidifying and then discharging the waste toner as described above is as follows. Particles of the toner used in the printing medium have a size of about 4 μm to 7 μm, and correspond to a harmful substance having a particulate size such as fine dust (PM10 and PM2.5). The waste toners in the particle form are suspended in the air in a case where they are leaked to the outside of the image forming apparatus 1. When the waste toners suspended in the air are inhaled into a human body, the waste toners may cause several diseases. The waste toner treatment device 100 may fundamentally block the waste toners in a particulate form such as fine dust from being suspended in the air to prevent a user from being exposed to the waste toners in the particulate form.

The image forming apparatus may use a waste toner bottle (WTB) in order to treat the waste toners. The WTB, which is a component performing a function of collecting waste toners generated after performing printing, needs a space for the WTB, and may thus may have less cost than the waste toner treatment device 100 according to the disclosure. However, a size of a space to be provided in the image forming apparatus for installing the WTB is determined by a size, a printing amount, and the like of the image forming apparatus. Therefore, WTBs of various sizes and shapes are used according to models of image forming apparatuses, and it is thus difficult to apply one WTB to several models of the image forming apparatuses through modularization.

The waste toner treatment device 100 solidifies and discharges the waste toners in the particle form generated after performing the printing in the image forming apparatus 1, and a space storing the waste toners in the pellet form may be a space relatively smaller than the space for the WTB. Therefore, a size of the waste toner treatment device 100 does not need to be changed according to the size and the printing amount of the image forming apparatus unlike the WTB, and the waste toner treatment device 100 modularized at a predetermined size may thus be applied to various models of the image forming apparatuses.

In addition, in the waste toner treatment device 100, components compressing the waste toners are disposed coaxially with each other and overlap each other in a waste toner compressing process, such that a space needed to treat the waste toners may be minimized. In addition, a driving portion providing a driving force in order to compress the waste toners may be disposed in a direction perpendicular to the components compressing the waste toners, such that an increase in a size in the waste toner treatment device 100 in a longitudinal direction may be limited. As described above, in the waste toner treatment device 100 according to the disclosure, a waste toner treatment space may be minimized, and an applicable range of the waste toner treatment device 100 may thus be widened from an office multi-function printer to a small printer for an individual user.

Hereinafter, a structure of the waste toner treatment device 100 according to an example will be described in detail with reference to the drawings.

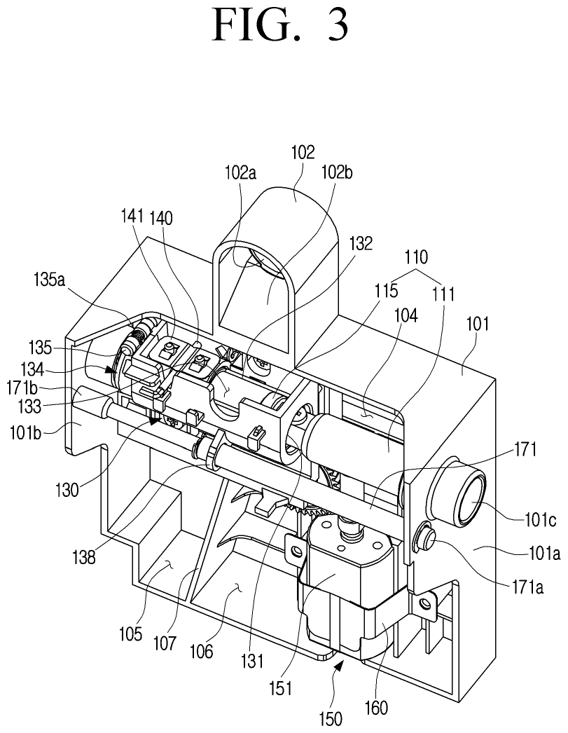

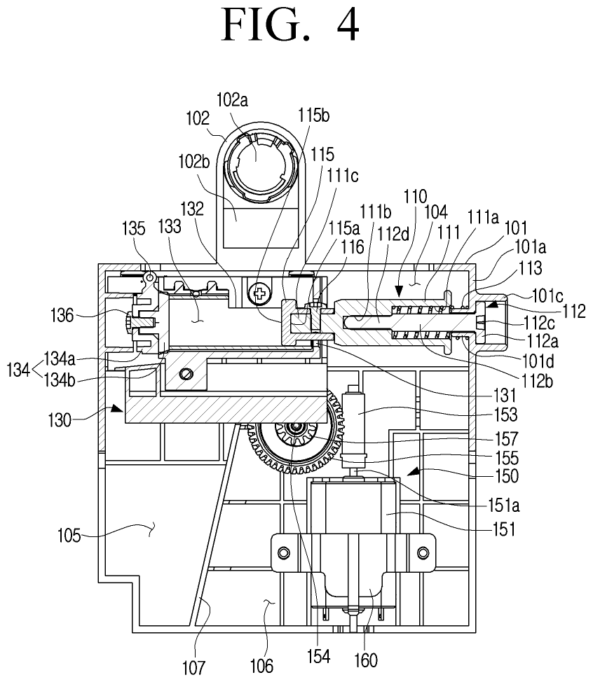

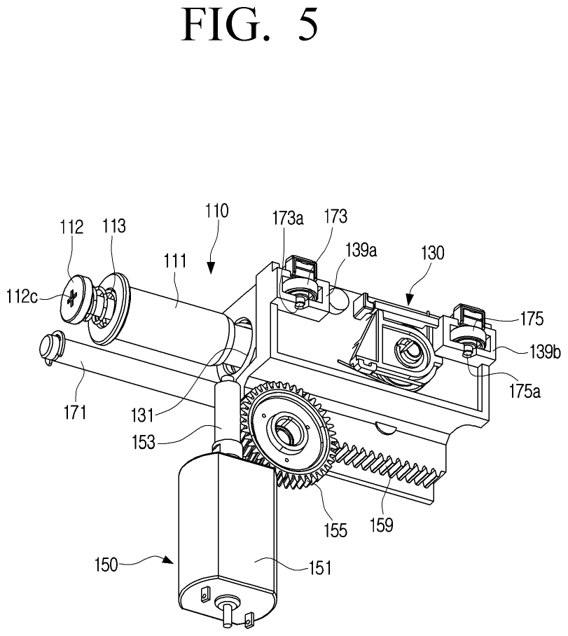

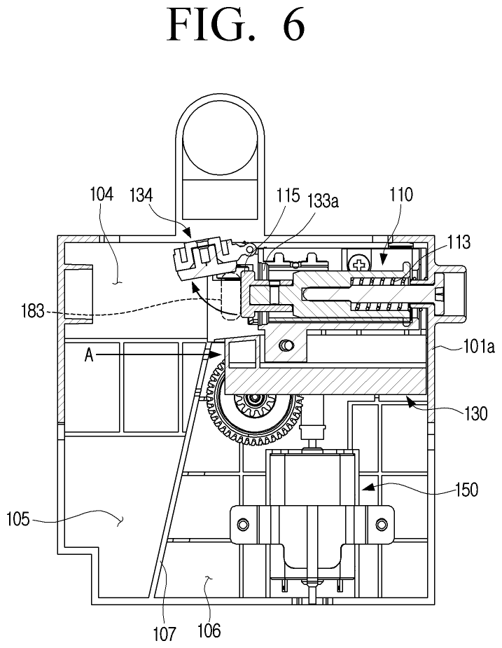

FIG. 2 is an exploded perspective view illustrating the waste toner treatment device according to an example, FIG. 3 is a perspective view illustrating an inner side of the waste toner treatment device according to an example, FIG. 4 is a cross-sectional view of the waste toner treatment device according to an example, illustrating a case where a heating portion is at a first position, FIG. 5 is a perspective view illustrating a gear connection structure of a driving portion of the waste toner treatment device according to an example, and FIG. 6 is a cross-sectional view of the waste toner treatment device according to an example, illustrating a case where the heating portion is at a second position.

Referring to FIG. 2, the waste toner treatment device 100 includes a housing 101 disposed inside the image forming apparatus 1, a waste toner discharging member 110, a heating portion 130 storing and heating the waste toners, and a driving portion 150 moving the heating portion 130 forward and backward along the waste toner discharging member 110.

One side of the housing 101 is opened, and a cover 108 may be detachably coupled to the opened portion. The housing 101 may be provided with an accommodation space in which the waste toner discharging member 110, the heating portion 130, and the driving portion 150 are disposed. The accommodation space includes a first region 104 and second and third regions 105 and 106 partitioned laterally by a partition wall 107 below the first region 104.

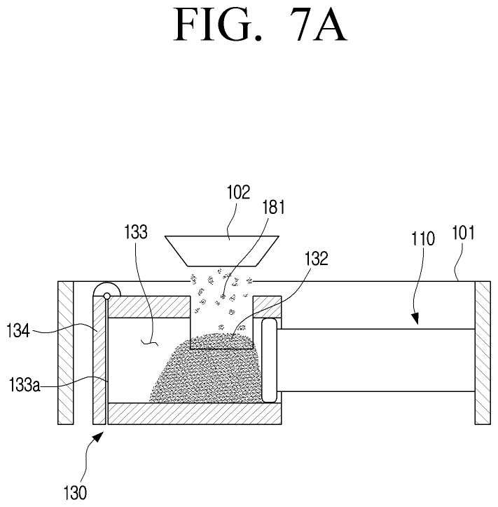

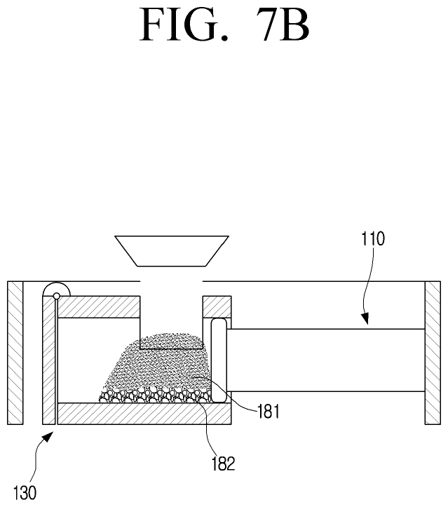

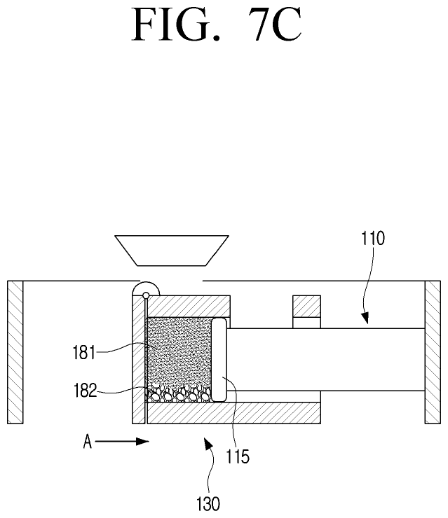

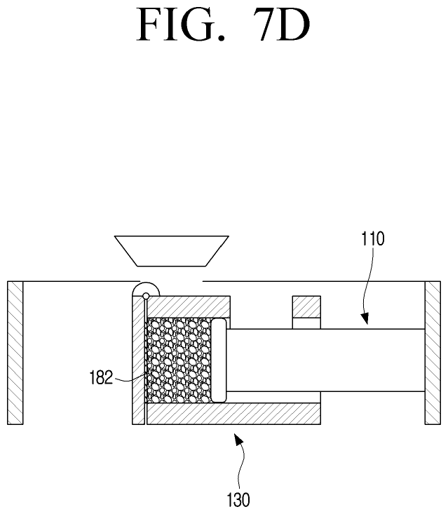

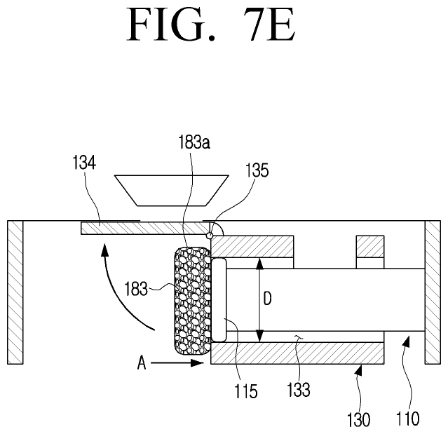

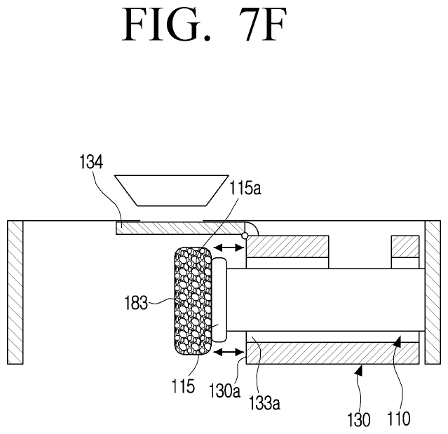

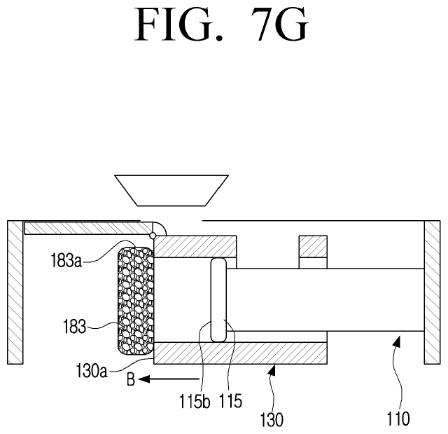

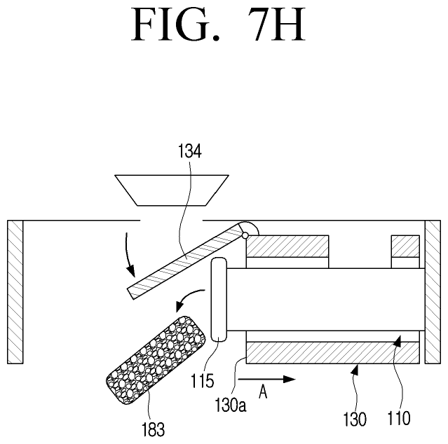

The waste toner discharging member 110 and the heating portion 130 disposed coaxially with each other may be accommodated in the first region 104. A solidified waste toner 183 (see FIG. 7) discharged from the inside of the heating portion 130 may be collected in the second region 105. The driving portion 150 may be disposed in the third region 106 through a gear connection with the heating portion 130. In this case, the driving portion 150 may be disposed in a direction substantially perpendicular to a moving direction of the heating portion 130 as a whole. Such a disposition of the driving portion 150 may limit an increase in a size of the waste toner treatment device 100 in a horizontal direction. An entire size of the waste toner treatment device 100 may be minimized by limiting an increase in a size of the waste toner treatment device 100 in a specific direction as described above. Therefore, the waste toner treatment device 100 may be easily installed in various models of image forming apparatuses having different sizes.

In addition, a passage portion 102 through which the waste toners are introduced may extend from an upper portion of the housing 101. The passage portion 102 has the same contour as that of an extending portion 109 formed at the cover 108, and may form a single passage that may guide the waste toners in a gravity direction in a case where the passage portion 102 is coupled to the extending portion 109.

A waste toner inlet 102a into which the waste toners in the particle form discharged from the waste toner outlet (not illustrated) of the waste toner withdrawal device 70 are introduced may be formed in the passage portion 102. An inclined surface 102b for guiding the waste toners introduced into the passage portion 102 through the waste toner inlet 102a in the gravity direction may be formed inside the passage portion 102.

Referring to FIG. 3, the waste toners introduced into the passage portion through the waste toner inlet 102a flow down along the inclined surface 102b and are collected in a collection space 133 through an opening 132 of the heating portion 130.

Referring to FIG. 4, the waste toner discharging member 110 discharges the waste toners existing in the collection space 133 of the heating portion 130 to the outside of the heating portion 130. One side of the waste toner discharging member 110 may be connected to one side wall 101a of the housing 101, such that forward and backward movement of the waste toner discharging member 110 is limited. Therefore, the waste toners are discharged from the heating portion 130 through the following process. That is, as the heating portion 130 at a first position (initial position) moves toward one side wall 101a of the housing 101, the collection space 133 of the heating portion 130 becomes gradually narrow by the other side of the waste toner discharging member 110. The waste toners are compressed while being pushed toward the left (toward a door 134) of the collection space 133. When the collection space 133 becomes smaller than a volume of the compressed waste toners according to continuous movement of the heating portion 130, the waste toners are naturally discharged to the outside of the heating portion 130 through an outlet 133a of the heating portion 130 in a state where they are in close contact with the other side of the waste toner discharging member 110.

The waste toner discharging member 110 includes an adjusting member 112 penetrating through one side wall 101a of the housing 101, a connecting member 111 screwed to the adjusting member 112, and a pressing member 115 detachably coupled to a tip of the connecting member 111.

A female screw portion 111b of an inner side of the connecting member 111 may be screwed to a male screw portion 112d formed at a tip of the adjusting member 112. The connecting member 111 may be elastically supported with respect to one side wall 101a of the housing 101 by a coil spring 113. The coil spring 113 has one end supported on one side wall 101a of the housing 101 and the other end supported on a tip of an insertion space 111a of the connecting member 111. The coil spring 113 provides a buffer function so that the waste toner discharging member 110 may move in a case where an excessive pressure is applied to the waste toner discharging member 110 when the waste toner discharging member 110 compresses the waste toners collected in the collection space 133 of the heating portion 130.

The adjusting member 112 may increase or decrease a size of the collection space 133 of the heating portion 130 by changing a position of the pressing member 115. The pressing member 115 may be coupled to the tip of the connecting member 111 to move together with the connecting member 111. Since the adjusting member 112 is fastened to the connecting member 111 in a screw manner, a position of the pressing member 115 may be changed by adjusting a position of the connecting member 111.

The adjusting member 112 may be formed in a substantially bolt shape. The adjusting member 112 penetrates through one side wall 101a of the housing 101, and is then disposed in the first region 104 of the housing 101. In this case, a head portion 112a of the adjusting member 112 may be disposed within a first guide protrusion 101c protruding outward of one side wall 101a of the housing 101, and a body portion 112b of the adjusting member 112 adjacent to the head portion 112a may be slidably guided by a second guide protrusion 101d protruding inward of one side wall 101a of the housing 101.

The adjusting member 112 may be rotated in one direction or in a reverse direction using a tool (for example, a screw driver) (not illustrated). To this end, the head portion 112a is provided with a groove 112c into which a tip of the tool may be inserted.

When the adjusting member 112 is rotated in one direction using the tool in a state where the connecting member 111 is elastically supported by the coil spring 113, the connecting member 111 may move in a direction adjacent to one side wall 101a of the housing 101. As the pressing member 115 moves together with the connecting member 111, the collection space 133 of the heating portion 130 may become wide. In addition, when the adjusting member 112 is rotated in the reverse direction, the connecting member 111 moves in a direction distant from the one side wall 101a of the housing 101. As the pressing member 115 moves together with the connecting member 111, the collection space 133 of the heating portion 130 may become narrow. The size of the collection space 133 of the heating portion 130 may be varied by rotating the adjusting member 112 in one direction or the reverse direction depending on an amount of the waste toners collected in the collection space 133 of the heating portion 130 as described above.

The pressing member 115 may be a member in contact with the waste toners collected in the collection space 133, and be coupled to the connecting member 111. For example, a tip 111c of the connecting member 111 may be detachably coupled to the pressing member 115 by a fastening bolt 116 with being inserted into a coupling hole 115a of the pressing member 115. Due to such a coupling structure, the pressing member 115 moves together with the connecting member 111.

The pressing member 115 may press the waste toners at a predetermined pressure, and may be formed of a material having heat resistance. For example, the pressing member 115 may be formed of a high strength metal material, a mold, or a high heat resistance material having elasticity.

In a case where the pressing member 115 may be formed of the high-strength metal material, a releasing layer (not illustrated) formed of a releasing agent such as perfluoro alkoxy (PFA), poly tetra fluoro ethylene (PTFE) may be coated on a contact surface 115b of the pressing member 115 so as to facilitate separation of the solidified waste toner at the time of discharging the solidified waste toner.

In addition, in a case where the pressing member 115 may be formed of a rigid material that does not have elasticity, an inner circumferential surface of the collection space 133 and the pressing member 115 in contact with the inner circumferential surface are not completely in close contact with each other, and some of the waste toners may thus leak between the inner circumferential surface of the collection space 133 and the pressing member 115. In order to prevent such leakage of the waste toners, the pressing member 115 may use an elastic ring (not illustrated) coupled along an outer circumferential surface thereof in contact with the inner circumferential surface of the collection space 133. Since the elastic ring also comes into contact with the waste toner subjected to a solidification process, the elastic ring may be formed of a releasing agent.

In addition, the pressing member 115 may be formed of a material having high elasticity, heat resistance, and releasability, for example, PTFE, which is a releasing agent. In this case, the elastic ring may not be used.

The heating portion 130 collects the waste toners in the particle form introduced into the passage portion 102, and heats and compresses the waste toners in the particle form to solidify the waste toners in the pellet form. The solidified waste toner 183 (see FIG. 6) may be discharged from the heating portion 130 by the waste toner discharging member 110 together with the forward and backward movement of the heating portion 130 to be dropped and collected into the second region 105 of the housing 101. A process of solidifying the waste toners in the particle form will be described later.

Referring to FIGS. 3 and 4, the heating portion 130 may be disposed in a substantially horizontal direction in the first region 104 of the housing 101 together with the waste toner discharging member 110. The heating portion 130 may be disposed coaxially with the waste toner discharging member 110, and may be moved forward and backward in the first region 104 along the waste toner discharging member 110 by power provided from the driving portion 150. In the disclosure, a forward movement direction of the heating portion 130 is defined as a direction adjacent to one side wall 101a of the housing 101, and a backward movement direction of the heating portion 130 is defined as a direction distant from one side wall 101a of the housing 101.

The heating portion 130 may be formed to have a length equal to that of the waste toner discharging member 110 or somewhat longer than that of the waste toner discharging member 110. When the heating portion 130 moves forward from a first position (which is an initial position of the heating portion 130 and may be a position where the heating portion 130 is disposed farthest from one side wall 101a of the housing 101), a region occupied by the waste toner discharging member 110 in the collection space 133 of the heating portion 130 increases, and the collection space 133 becomes thus narrow. When the collection space 133 becomes narrow according to the forward movement of the heating portion 130 as described above, the waste toners present in the collection space 133 may be compressed by the pressing member 115. When the waste toners are compressed, the heating portion 130 itself generates heat at a predetermined temperature so that the waste toners in the particle form may be melted to some degree to be aggregated into a lump of a predetermined size.

The heating portion 130 may include a body in which a heating element (not illustrated) is buried, a heating layer surrounding the body, a molding layer surrounding the heating layer, and a releasing layer coated on an inner circumferential surface of the body. The body may be formed of a metal material having high thermal conductivity in order to facilitate transfer of heat generated from the heating element. A flexible heat source or a coil-type heat source may be used as the heating layer so as to surround the body. The molding layer may be formed of a heat insulating material in order to minimize heat loss. The releasing layer may be formed of a releasing agent such as PFA or PTFE so that the waste toners adhered to each other while being solidified in the collection space 133 are easily discharged from the collection space 133.

A heat generating temperature of the heating portion 130 may be measured through a temperature sensor 140 fixed to the heating portion 130 by a bracket 141. A controller (not illustrated) may control heat generation of the heating portion 130 by determining the heat generating temperature of the heating portion 130 measured by the temperature sensor 140.

The opening 132 for collecting the waste toners in the particle form flowing down along the inclined surface 102b of the passage portion 102 in the collection space 133 at the first position of the heating portion 130 may be formed at a position of the heating portion 130 corresponding to the passage portion 102.

An insertion hole 131 into which the pressing member 115 may be inserted may be formed at one side of the heating portion 130, and the outlet 133a (see FIG. 6) through which the solidified waste toner is discharged from the collection space 133 may be formed at the other side of the heating portion 130.

In the heating portion 130, a door 134 capable of opening and closing the outlet 133a is hinge-connected through a hinge shaft 135. The door 134 may prevent the waste toners in the particle form from being leaked through the outlet 133a during a process of solidifying the waste toners in the collection space 133. The door 134 may be elastically supported in a direction in which it closes the outlet 133a by a torsion spring 135a disposed on the hinge shaft 135.

The door 134 includes an external door 134a and an internal door 134b coupled to an inner side of the external door 134a by a fastening bolt 136. The external door 134a may be formed of a heat insulating material so as to minimize loss of the heat generated in the heating portion 130, and the internal door 134b may be formed of a releasing agent such as PFA or PTFE since it is in contact with the waste toners.

Referring to FIGS. 4 and 5, in the driving portion 150, a driving motor 151 for generating power may be fixedly disposed in the third region 106 of the housing 101 by a bracket 160. The driving motor 151 may be a motor capable of forward rotation and reverse rotation.

The driving portion 150 may include a power transmission structure in which a worm gear structure and a rack and pinion structure are combined with each other in order to transmit the power generated from the driving motor 151 to the heating portion 130.

The worm gear structure may include a worm 153 (fourth gear) coupled to a driving shaft 151a of the driving motor 151 and a worm gear 155 (third gear) rotatably coupled to the housing 101 through a rotation shaft 154 disposed in the housing 101 and gear-coupled to the worm 153.

The rack and pinion structure may include a pinion 157 (first gear) concentrically coupled to the worm gear 155 to rotate together with the worm gear 155 and having a diameter smaller than that of the worm gear 155 and a rack 159 (second gear) coupled to a lower portion of the heating portion 130 along a longitudinal direction of the heating portion 130 and gear-coupled to the pinion 157. In this case, the rack 159 may be formed integrally with the heating portion 130.

The driving portion 150 may move the heating portion 130 forward and backward between the first position (see FIG. 4) and the second position (see FIG. 6). In a case where a gear structure may be adopted as the power transmission structure, when the heating portion 130 moves, if a direction of a force generated between respective gears and a moving direction of the heating portion 130 are different from each other, a step-out phenomenon of the gears may appear. In order to prevent such a phenomenon, in the disclosure, a linear guide portion guiding the heating portion 130 so that the heating portion 130 may move in a constant linear direction is provided.

Referring to FIG. 3, the linear guide portion may include a guide rod 171 disposed in parallel with the heating portion 130 along the longitudinal direction of the heating portion 130. One side 171a of the guide rod 171 may be fixed to one side wall 101a of the housing 101, and the other side 171b of the guide rod 171 may be fixed to the other side wall 101b of the housing 101.

The heating portion 130 may be provided with a coupling ring 138 protruding toward the guide rod 171. The guide rod 171 may be slidably coupled to the coupling ring 138. Therefore, the heating portion 130 may be linearly guided by the guide rod 171 when moving between the first position and the second position by the power transmitted from the driving portion 150, and may thus move smoothly without the step-out phenomenon of the gears.

Referring to FIG. 5, the linear guide portion may include a plurality of guide rollers 173 and 175 in order to guide smoother linear movement of the heating portion 130. The plurality of guide rollers 173 and 175 may be rotatably disposed on the heating portion 130 and may be disposed on an opposite side to a side on which the coupling ring 138 is formed. The guide rollers 173 and 175 may be rotatably coupled to grooves 139a and 139b formed in the heating portion 130 at predetermined intervals, through rotation shafts 173a and 175a, respectively.

The number of guide rollers 173 and 175 is not limited, and may be one or three or more.

In addition, in the waste toner treatment device 100, a position sensor (not illustrated) capable of detecting a moving position of the heating portion 130 may be disposed inside the housing 101 or the cover 108. Therefore, the controller may more accurately control the moving position of the heating portion 130 by determining a position value sensed by the position sensor during the process of solidifying the waste toners.

Hereinafter, processes of solidifying the waste toners in the particle form using the waste toner treatment device 100 according to an example disclosure will be sequentially described with reference to the drawings.

FIGS. 7A to 7H are schematic views sequentially illustrating processes of solidifying and discharging waste toners collected through the waste toner treatment device according to an example. The forward and backward movement of the heating portion 130 may be performed by the driving portion 150 described above, and a description for a detailed operation of the driving portion 150 will hereinafter be omitted.

Referring to FIG. 7A, the heating portion 130 moves to the first position so that the waste toners may be collected through the passage portion 102. At the first position, the opening 132 of the heating portion 130 is positioned so as to correspond to the passage portion 102. Waste toners 181 in a particle form supplied through the passage portion 102 are dropped in a gravity direction and are introduced into the collection space 133 through the opening 132 of the heating portion 130.

Referring to FIG. 7B, when the introduction of the waste toners 181 in the particle form is completed, the heating portion 130 may be pre-heated to a temperature of T_{L} or more before being moved to a heating position (see FIG. 7C). Here, T_{L} is a temperature higher than a glass transition temperature (T_{G}) of the waste toner. During a period in which the heating portion 130 is pre-heated, some of the waste toners 181 in the particle form introduced into the collection space 133 are transformed into waste toners 182 in a small lump form while being aggregated with adjacent particles by heat.

In a case where the heating portion 130 may be moved to the heating position without being pre-heated, there is a risk that fine waste toner particles similar to fine dust will be leaked into a fine gap that may be formed due to a manufacturing tolerance or the like of the waste toner treatment device 100. A process of pre-heating the heating portion 130 may prevent such leaking of the fine waste toner particles.

Referring to FIG. 7C, the heating portion 130 for which pre-heating is completed is moved to the heating position along a direction of arrow A.

Referring to FIG. 7D, the waste toners 181 and 182 of the collection space 133 of the heating portion 130 at the heating position are heated and solidified in an appropriate temperature range. In this case, the appropriate temperature range may be limited to a temperature range of T_{O} larger than T_{G} and smaller than T_{H} (T_{G}<T_{O}<T_{H}). Here, T_{H} is a heat-resistant limit temperature of the heating portion 130.

Most of the waste toners 181 in the particle form are entangled with each other while being melted during a period in which the waste toners are heated within the appropriate temperature range as described above, such that most of the waste toners 181 in the particle form may be transformed into the waste toners 182 in the small lump form.

Referring to FIG. 7E, when the solidification of the waste toners in the collection space 133 of the heating portion 130 is completed, the heating may be stopped and the heating portion 130 may be moved by a predetermined distance in the direction of arrow A. In this process, the waste toners in the collection space 133 may be compressed in an opposite direction to the moving direction of the heating portion 130 by the pressing member 115.

Next, when the heating portion 130 moves in the direction of arrow A, a waste toner 183 aggregated and solidified in one lump form is pushed out of the collection space 133 in a state where it is attached to the pressing member 115. In this case, a volume of the waste toner 183 is slightly increased due to elasticity of the waste toner 183 itself while a compressed state of the waste toner 183 is released, such that the volume of the waste toner 183 becomes larger than a diameter of the collection space 133.

When the solidified waste toner 183 is completely discharged from the collection space 133 of the heating portion 130, the movement of the heating portion 130 may be stopped, and the waste toner 183 is cooled. The waste toner 183 may be maintained in a state where it is attached to the pressing member 115 while being cooled.

In a case where the waste toner is cooled in the collection space 133, the waste toner is still in a high temperature state, and it thus takes a long time to cool the waste toner, and if the waste toner is stiffly solidified in the collection space 133, the waste toner is strongly stuck to the inner circumferential surface of the collection space 133, and a large force may thus be needed to discharge the waste toner to the outside of the heating portion 130. Therefore, for example the cooling of the solidified waste toner 183 may be performed after the solidified waste toner 183 is discharged to the outside of the heating portion 130 immediately after the heating ends.

Referring to FIG. 7F, the waste toner 183 for which the cooling is completed remains attached to an end portion 130a of the heating portion 130 and the pressing member 115.

In this state, the heating portion 130 may be repeatedly moved forward and backward by a predetermined distance to remove the solidified waste toner 183 from the end portion 130a of the heating portion 130.

Referring to FIG. 7G, the heating portion 130 may be moved in a direction of arrow B in order to remove the waste toner 183 from the pressing member 115.

Therefore, the pressing member 115 may be relatively drawn into the collection space 133 of the heating portion 130. On the other hand, the stiffly solidified waste toner 183 may be naturally separated from the contact surface 115b of the pressing member 115 since the stiffly solidified waste toner 183 may not enter the collection space 133 due to a contour portion 183a thereof caught by the end portion 130a of the heating portion 130.

The waste toner treatment device 100 according to the disclosure does not need a separate waste toner separation device for separating the waste toner 183 from the heating portion 130 and the pressing member 115.

In this state, the solidified waste toner 183 may be dropped by its own weight and be collected in the second region 105 of the housing 101.

When the waste toner 183 may be again attached to the end portion 130a of the heating portion 130 in an operation illustrated in FIG. 7G, if the heat portion 130 is again moved in the direction of arrow A as illustrated in FIG. 7H, the waste toner 183 may be easily separated from the heating portion 130 by the pressing member 115.

Hereinafter, a configuration of a waste toner treatment device according to another example will be described with reference to the drawings. The waste toner treatment device 100 according to the example described above solidifies the waste toner while transporting the waste toner in the linear direction, while a waste toner treatment device 200 according to another example described later has a structure in which a waste toner is solidified by rotational movement.

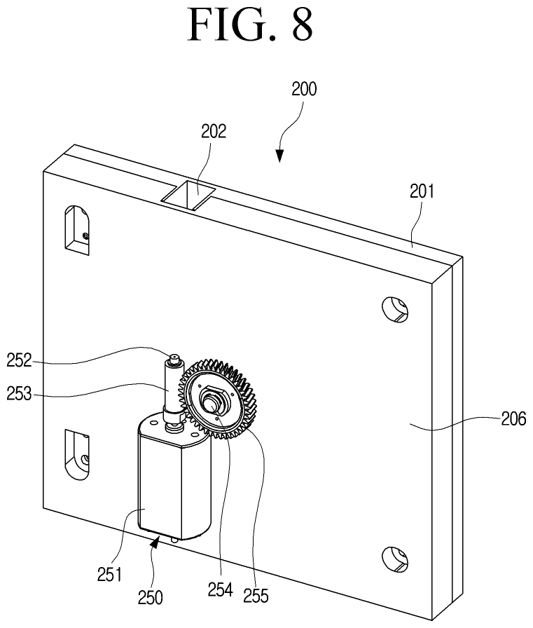

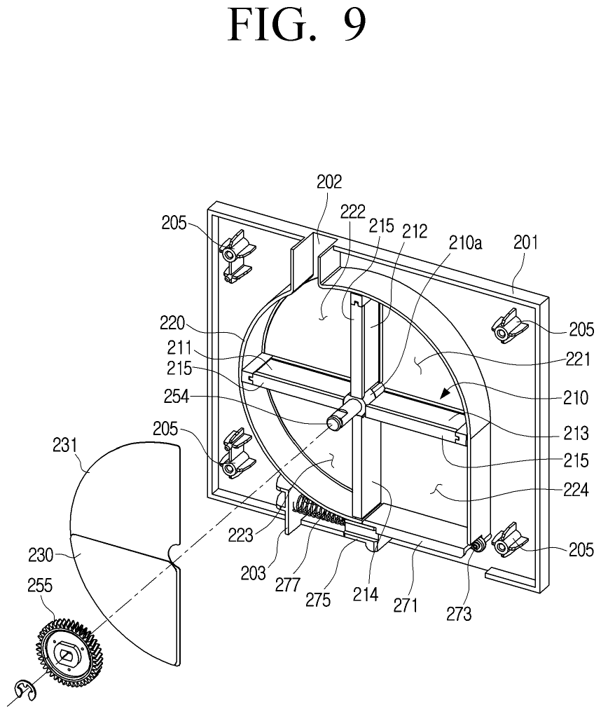

FIG. 8 is a perspective view illustrating a waste toner treatment device according to another example, and FIG. 9 is an exploded perspective view illustrating an inner side of the waste toner treatment device according to another example.

Referring to FIG. 8, a waste toner treatment device 200 according to another example may include a housing 201 and a cover 206 capable of closing an opened one side of the housing 201. The housing 201 and the cover 206 are portions forming an outer shape of the waste toner treatment device 200, and may be formed of a mold material having low heat conductivity in order to minimize heat loss.

A case where the housing 201 and the cover 206 may be formed in a rectangular shape has been illustrated in the disclosure, but the housing 201 and the cover 206 may also be formed in a circular shape since transport of waste toners is performed in a rotational direction. A plurality of bosses 205 (see FIG. 9) to which fastening screws (not illustrated) are coupled may be formed so that the housing 201 and the cover 206 may be coupled to each other through the fastening screws may be formed in the housing 201.

A passage portion 202 for introducing the waste toners in a particle form transported from the waste toner withdrawal device 70 (see FIG. 1) and introduced into the housing 201 may be formed in the housing 201.

In the waste toner treatment device 200, a driving portion 250 may be disposed outside the housing 201 and the cover 206 unlike the waste toner treatment device 100 described above. Therefore, the housing 201 may be formed to have a slim width, such that an assembling operation of the waste toner treatment device 200 at the time of installing the waste toner treatment device 200 in the image forming apparatus 1 may be more easily performed.

Referring to FIG. 9, a region in which solidification of the waste toners is performed by a partition member 220 provided inside the housing 201 may be secured in the housing 201. The partition member 220 may be partitioned into first to fourth quadrant regions 221, 222, 223, and 224 by a waste toner discharging member 210.

The waste toner discharging member 210 may include first to fourth blades 211, 212, 213, and 214 disposed at intervals of 90° around a hub 210a. However, the waste toner discharging member 210 does not need to necessarily include four blades, and solidifying the waste toners may be carried out even though the waste toner discharging member 210 includes less than four blades, for example, three blades disposed adjacent to each other at intervals of 90°. When the number of blades of the waste toner discharging member 210 is three, the number of regions divided within the partition member 220 may also be three and a separation interval may be varied, for example at intervals of 120°.

For example, the releasing layers are coated on surfaces of the respective blades 211, 212, 213, and 214 in contact with the waste toners. In addition, sealing members 215 formed of a material having releasability and elasticity may be coupled, respectively, to contours of the blades 211, 212, 213, and 214 in contact with a metal plate 231 so that the waste toners in the particle form are not leaked. In the disclosure, the sealing members 215 may also be coupled to and used for contours of the three blades 211, 212, and 213. This is to consider that regions where the leakage of the waste toners in particle form may occur are limited to the second and third quadrant regions 222 and 223.

Portions of the partition member 220 corresponding to the first to third quadrant regions 221, 222, and 223 may be formed as curved lines, and a portion of the partition member 220 corresponding to the fourth quadrant region 224 may be formed as a straight line.

The second quadrant region 222 may be connected to the passage portion 202 to be used as a space collecting the waste toners in the particle form. A detection sensor (not illustrated) capable of detecting whether or not a predetermined amount of waste toners in the particle form are introduced into the second quadrant region 222 may be disposed at a predetermined position of the second quadrant region 222.

The third quadrant region 223 may be used as a region heating the waste toners, and a heating portion 230 formed of a plate-shaped heater may be disposed before and after the third quadrant region 223, respectively.

In addition, the metal plate 231 may be disposed before and after the second and third quadrant regions 222 and 223, respectively, to cover the second and third quadrant regions 222 and 223. In this case, the waste toners come into contact with an inner surface of the metal plate 231. Therefore, a coating layer may formed on the inner surface of the metal plate 231 using a releasing agent such as PFA or PTFE so that the solidified waste toner is easily separated.

When the waste toner discharging member 210 rotates, the respective blades 211, 212, 213, and 214 continuously come into contact with and rub against the inner surface of the metal plate 231. When the heating portion 230 is located on the inner surface of the metal plate 231, the respective blades 211, 212, 213, and 214 may rub against the heating portion 230 to cause a decrease in a lifespan of the heating portion 230. For example, the heating portion 230 may be disposed on an outer surface of the metal plate 231 at a position corresponding to the third quadrant region 223 to avoid or prevent the decrease in lifespan of the heating portion 230 due to the blades 211, 212, 213, and 214 rubbing against the heating portion 230. However, in a case the heating portion 230 is treated to have high surface strength, the metal plate 231 may be omitted and the heating portion 230 may be manufactured in a semi-circle shape to cover the second and third quadrant regions 222 and 223 or may be manufactured in a quarter-circle shape to cover the third quadrant region 223.

In the disclosure, the metal plate 231 is formed in the semi-circle shape so as to correspond to the second and third quadrant regions 222 and 223. However, the metal plate 231 is not limited thereto, and may also be manufactured in a quarter shape of a circle plate so as to correspond to the third quadrant region 223.

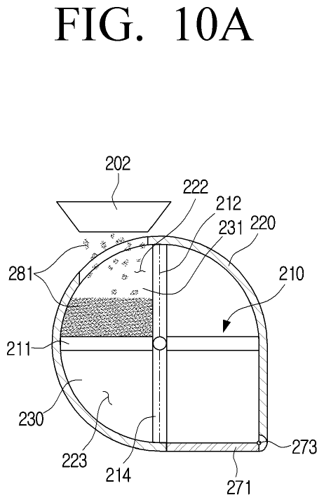

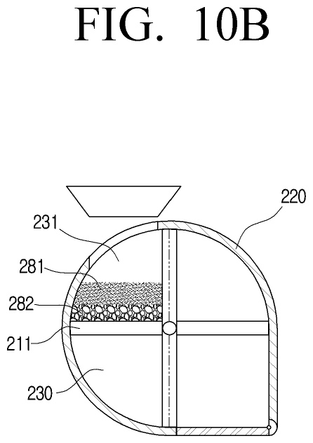

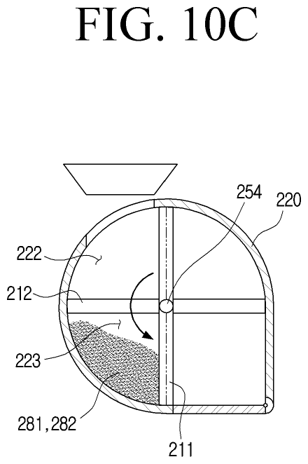

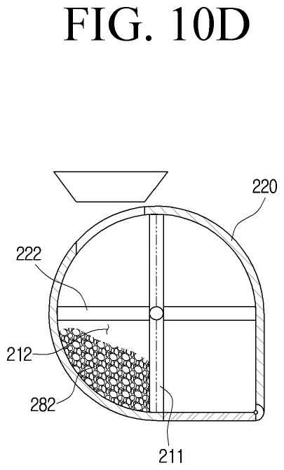

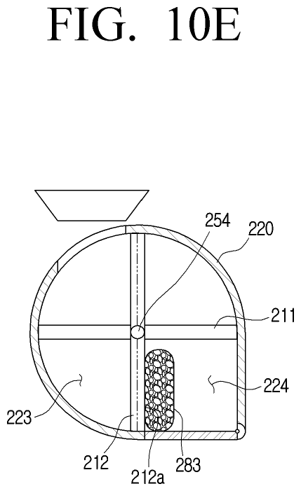

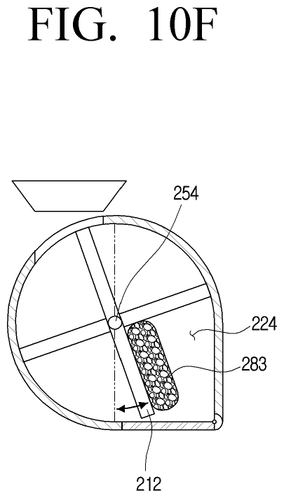

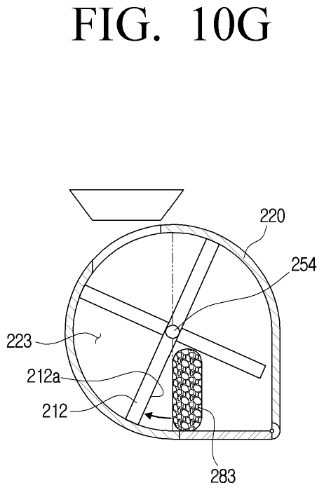

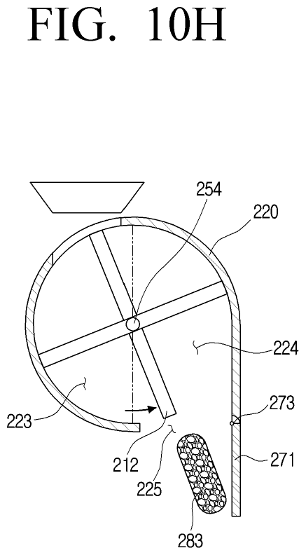

A side surface of the fourth quadrant region 224 is surrounded by the partition member 220, but an opening 225 (see FIG. 10H) opened and closed by a door 271 is formed at a lower side of the fourth quadrant region 224.

The door 271 may be hinge-connected to the housing 201 through a hinge shaft 273, and be locked and unlocked by a locking member 275 disposed below the partition member 220. The locking member 275 may be elastically supported by a coil spring 277. The coil spring 277 may be positioned between a support piece 203 and the locking member 275 and presses the locking member 275 toward the door 271.

The door 271 and the locking member 275 may be omitted and the opening 225 (see FIG. 10H) of the fourth quadrant region 224 may be formed in an always open state.

Referring to FIGS. 8 and 9, the driving portion 250 may include a driving motor 251 capable of forward rotation and reverse rotation, a worm 253 coupled to a driving shaft 252 of the driving motor 251, and a worm gear 255 gear-connected to the worm 253.

The worm gear 255 may be coupled to a rotation shaft 254 penetrating through and coupled to the hub 210a of the waste toner discharging member 210. Therefore, when the worm gear 255 rotates, the rotation shaft 254 and the waste toner discharging member 210 rotate together in the same direction.

The waste toner treatment device 200 may use a sensor (not illustrate) for detecting positions of the blades when the waste toner discharging member 210 rotates. The sensor may be located at any one of boundaries of the respective quadrant regions. For example, the sensor may be disposed at a position not in contact with the heating portion 230. For example, the sensor may be disposed at a boundary between the first and fourth quadrant regions 221 and 224.

Since such a waste toner treatment device 200 does not have an effect that the waste toners are compressed between the pressing member 115 having a piston shape and the door 134, a size of the solidified waste toner may be somewhat larger than that in the waste toner treatment device 100 described above. However, the waste toner treatment device 200 has a structure simpler than that of the waste toner treatment device 100 described above, and all components for treating the waste toners may be disposed inside the slim housing 201 and the cover 206, and the waste toner treatment device 200 may thus may have a more compact size than the waste toner treatment device 100 described above.

Hereinafter, processes of solidifying the waste toners in the particle form through the waste toner treatment device 200 according to another example will be sequentially described with reference to the drawings.

FIGS. 10A to 10H are schematic views sequentially illustrating processes of solidifying and discharging waste toners collected through the waste toner treatment device according to another example. The rotation of the waste toner discharging member 210 in one direction and a reverse direction is performed by the driving portion 250 described above, and a description for a detailed operation of the driving portion 250 will hereinafter be omitted.

Referring to FIG. 10A, waste toners 281 in a particle form are introduced into the second quadrant region 222 through the passage portion 202.

Referring to FIG. 10B, when the introduction of the waste toners 281 in the particle form is completed, the heating portion 230 is pre-heated to a temperature of T_{L} or more before being moved to a heating position (see FIG. 100). Here, T_{L} is a temperature higher than a glass transition temperature (T_{G}) of the waste toner. During a period in which the heating portion 230 may be pre-heated, some of the waste toners 281 in the particle form introduced into the second quadrant region 222 are transformed into waste toners 282 in a small lump form while being aggregated with adjacent particles by heat.

In a case where the heating portion 230 is moved to the heating position without being pre-heated, there is a risk that fine waste toner particles similar to fine dust will be leaked into a fine gap that may be formed due to a manufacturing tolerance or the like of the waste toner treatment device 200. A process of pre-heating the heating portion 230 may prevent such leaking of the fine waste toner particles.

Referring to FIG. 100, the waste toner discharging member 210 is rotated counterclockwise by 90° in a state where the pre-heating of the heating portion is completed. Therefore, the waste toners 281 and 282 accumulated on the first blade 211 are transported to the third quadrant region 223 by their own weights.

Referring to FIG. 10D, the waste toners 281 and 282 of the third quadrant region 223 are heated and solidified in an appropriate temperature range by driving the heating portion 230. In this case, the appropriate temperature range may be limited to a temperature range of T_{O} larger than T_{G} and smaller than T_{H} (T_{G}<T_{O}<T_{H}). Here, T_{H} is a heat-resistant limit temperature of the heating portion 230.

Most of the waste toners 281 in the particle form are entangled with each other while being melted during a period in which the waste toners are heated within the appropriate temperature range as described above, such that most of the waste toners 281 in the particle form may be transformed into the waste toners 282 in the small lump form.

Referring to FIG. 10E, when the solidification of the waste toners in the third quadrant region 223 is completed, the heating is stopped and the waste toner discharging member 210 is rotated counterclockwise by 90°. A waste toner 283 aggregated in one lump form is discharged from the third quadrant region 223 to the fourth quadrant region 224 in a state where it is attached to a side 212a the second blade 212. In this case, a volume of the waste toner 283 is horizontally increased due to elasticity of the waste toner 283 itself. In this state, the waste toner 283 in the lump form is cooled.

Referring to FIG. 10F, the waste toner 283 for which the cooling is completed remains attached to the second blade 212. In this state, the waste toner discharging member 210 is rotated so that the second blade 212 alternately reciprocates clockwise and counterclockwise within the third and fourth quadrant regions 223 and 224.

In this case, both sides of the waste toner 283 solidified in a state where the volume of the waste toner 283 is increased are caught by end portions of the metal plate 231 present in the third quadrant region 223, and at the same time, the waste toner 283 rubs against inner surfaces of the housing 201 and the cover 206 corresponding to the fourth quadrant region 224. When this process is repeatedly performed, the waste toner 283 may be separated from the second blade 212.

Referring to FIG. 10G, the waste toner discharging member 210 is rotated clockwise by a predetermined angle so that the second blade 212 moves to the third quadrant region 223 in order to completely separate the waste toner 283 from the second blade 212.

Therefore, a contour portion of the stiffly solidified waste toner 283 is caught by the fourth quadrant region 224, such that the solidified waste toner 283 may be naturally separated from the second blade 212.

Referring to FIG. 10H, after the opening 225 is opened by rotating the door 271 counterclockwise around the hinge axis 273, when the second blade 212 is moved from the third quadrant region 223 to the fourth quadrant region 224, the second blade 212 pushes out the waste toner 183. Therefore, the waste toner may be discharged to the outside of the fourth quadrant region 224 through the opening 225.

Although various examples have been illustrated and described hereinabove, the disclosure is not limited to the examples described above, but may be variously modified without departing from the spirit and scope of the disclosure or as claimed in the claims. These modifications are to fall within the scope of the disclosure.

1. A waste toner treatment device, comprising:
a waste toner discharging member;
a heating portion to heat waste toners within the heating portion; and
a driving portion to move the heating portion along a longitudinal direction of the waste toner discharging member so as to form a waste toner solidified within the heating portion from the waste toners heated by the heating portion, and
the waste toner discharging member is to discharge the waste toner solidified within the heating portion outside of the heating portion.

2. The waste toner treatment device as claimed in claim 1, wherein the heating portion includes:
an inlet through which the waste toners are introduced into the heating portion, and
an outlet through which the waste toner solidified within the heating portion is discharged outside of the heating portion.

3. The waste toner treatment device as claimed in claim 2, wherein the waste toner discharging member includes a pressing member formed at a tip of the waste toner discharging member and in close contact with an inner circumferential surface of the heating portion.

4. The waste toner treatment device as claimed in claim 3, wherein the pressing member is formed of a synthetic resin having elasticity.

5. The waste toner treatment device as claimed in claim 3, wherein the pressing member includes:
a metal member coupled to the tip of the waste toner discharging member, and
an elastic ring coupled to an outer periphery of the metal member.

6. The waste toner treatment device as claimed in claim 2, wherein the heating portion includes a door to elastically open and close the outlet.

7. The waste toner treatment device as claimed in claim 1, wherein the driving portion includes:
a driving motor to perform forward and reverse rotation,
a first gear to receive power from the driving motor, and
a second gear coupled to the heating portion and gear-connected to the first gear.

8. The waste toner treatment device as claimed in claim 7, wherein the driving portion includes:
a third gear concentrically fixed to the first gear, and
a fourth gear coupled to a driving shaft of the driving motor and gear-connected to the third gear, and
the driving motor is disposed perpendicular to the waste toner discharging member.

9. The waste toner treatment device as claimed in claim 1, comprising a housing, formed of a heat insulating material, in which the waste toner discharging member, the heating portion, and the driving portion are provided.

10. The waste toner treatment device as claimed in claim 9, wherein the housing includes:
a first space in which the heating portion and the waste toner discharging member are disposed,
a second space to collect the solidified waste toner below the heating portion, and
a third space partitioned from the second space by a partition wall and in which the driving portion is disposed.

11. The waste toner treatment device as claimed in claim 1, comprising a linear guide portion to guide movement of the heating portion in the longitudinal direction.

12. The waste toner treatment device as claimed in claim 11, wherein
the linear guide portion includes a guide rod which is disposed in parallel to the heating portion along the longitudinal direction,
the guide rod is slidably connected to one side of the heating portion.

13. The waste toner treatment device as claimed in claim 12, wherein the linear guide portion includes at least one guide roller rotatably connected to another side of the heating portion.

14. The waste toner treatment device as claimed in claim 1, further comprising a position sensor to sense a position of the heating portion.

15. An image forming apparatus, comprising:
a body;
a printing engine, disposed in the body, to perform an image forming operation;
a waste toner withdrawal device to obtain waste toners generated during the image forming operation; and
a waste toner treatment device to treat the waste toners obtained by the waste toner withdrawal device and introduced to the waste toner treatment device from the waste toner withdrawal device, the waste toner treatment device including:
a waste toner discharging member,
a heating portion to heat the waste toners within the heating portion, and
a driving portion to move the heating portion along a longitudinal direction of the waste toner discharging member so as to form a waste toner solidified within the heating portion from the waste toners heated by the heating portion, and
the waste toner discharging member is to discharge the waste toner solidified within the heating portion outside of the heating portion.
